(19) United States
(12) Patent Application Publication
(10) Pub. No.: US 2012/0056893 A1
(43) Pub. Date: Mar. 8, 2012

(54) SIMILAR IMAGE SEARCH DEVICE, SIMILAR IMAGE SEARCH METHOD, AND COMPUTER PROGRAM

(75) Inventor: Ayahiro Nakajima, Matsumoto-shi (JP)

(73) Assignee: SEIKO EPSON CORPORATION, Tokyo (JP)

(21) Appl. No.: 13/226,425

(22) Filed: Sep. 6, 2011

(30) Foreign Application Priority Data
Sep. 8, 2010 (JP) 2010-200577

(51) Int. Cl. G09G 5/377; G09G 5/02

(52) U.S. Cl. 345/582; 345/634

(57) ABSTRACT

A similar image search device includes an image database where image data is accumulated in advance, and a search unit which searches with regard to an input image from a search request origin for images which are similar to the input image from image data accumulated in the image database, where the search unit has a determination unit, which determines degrees of similarity of the input image and each image accumulated in the image database using a plurality of determination standards obtained by applying and combining weights of differences in a plurality of characteristic values which express the characteristics of an image, and a tuning screen transmission unit, which transmits images where the degrees of similarity determined by the determination unit satisfy predetermined conditions to the search request origin as a tuning screen which is divided into groups for each of the determination standards.

Priority is claimed under 35 U.S.C. §119 to Japanese Application No. 2010-200577 filed on Sep. 8, 2010 which is hereby incorporated by reference in its entirety.

### BACKGROUND

1. Technical Field

The present invention relates to a similar image search device, a similar image search method, and a computer program.

2. Related Art

As a technique for searching for image data, which shows an image which is desired by a user, from image data which has accumulated in a database, for example, in Japanese Unexamined Patent Application Publication No. 2004-272314, there is disclosed that image data is searched for by setting a search condition in relation to attributes of image data (imaging date, imaging mode, or the like) or a search condition in relation to characteristics of image data content (for example, a degree of similarity with regard to a predetermined template image).

In addition, instead of searching for image data based on a degree of similarity with regard to a predetermined template image, searching for image data which is similar with regard to image data which is input by a user may also be considered.

In a case of performing a typical search for information, there are cases where information which is requested by a user is different even if the same search equation is used. Therefore, using an equation which calculates preferences of a user (referred to as a “user preference calculation equation”), by changing weighting with regard to each parameter in the user preference calculation equation according to a search history of the user (history such as search date and search terms), a search result which is appropriate to the preferences of the user is obtained.

However, when a user performs an initial information search, when there is a period with no search, when preferences change significantly, or the like, the weighting of the parameters in the user preference calculation equation is not appropriate.

It may be considered that which information a user wants to search for is able to be set in a different manner from a search equation. However, in a case where a search target is image data, since the characteristic amounts used in a degree of similarity calculation are different depending on the vendors of the search systems, there are no general nouns or the like. As a method for adjusting an image, there is a method where the image is displayed on a screen, and brightness, color balance, contrast, and the like are adjusted using a slider control, but using the image adjusting method as a search condition is not possible.

### SUMMARY

An advantage of some aspects of the invention is that a similar image search device, a similar image search method, and a computer program are provided where it is possible to easily adjust to preferences of a user when searching for a similar image.

According to an aspect of the invention, there is provided a similar image search device including an image database where image data is accumulated in advance, and a search unit which searches with regard to an input image from a search request origin for images which are similar to the input image from image data accumulated in the image database, where the search unit has a determination unit, which determines degrees of similarity of the input image and each image expressed by individual image data accumulated in the image database using a plurality of determination standards obtained by applying and combining weights of differences in a plurality of characteristic values which express the characteristics of an image, and a tuning screen transmission unit, which transmits images where the degrees of similarity determined by the determination unit satisfy predetermined conditions to the search request origin as a tuning screen which is divided into groups for each of the determination standards.

By transmitting images obtained using different determination standards to the search request origin (user) as a tuning screen which is divided into groups for each of the determination standards, it is possible for a user to select the images which match the preferences of the user from the screen.

The search unit has a unit which accumulates image search histories from the search request origin and determines preferences of the search request origin, and the determination unit and the tuning screen transmission unit perform transmission of the determination and the tuning screen in a case where the unit which determines the preferences is not able to determine the preferences of a user due to the image search history from the search request origin being insufficient. That is, in a case where the preferences of the user are not able to be determined, it is possible to determine the preferences of the user and it is possible to perform tuning of the search unit.

It is possible for the determination unit and the tuning screen transmission unit to perform transmission of the determination and the tuning screen when there is a request from the search request origin. For example, tuning of the search unit is possible in a case where the preferences of a user change significantly or in a case where there is a desire to perform a search without any influence from search histories to that point.

It is possible to use color, shape, texture and the like as the characteristic value used in the determination standard. For example, images with the same color as the input image, images with the same shape as the input image, images with the same texture as the input image are each displayed in groups. According to this, it is possible for the user to select what the user wants to emphasize when searching.

It is possible for the determination unit and the tuning screen transmission unit to repeat transmission of the determination and the tuning screen by further changing the plurality of determination standards. According to this, it is possible to perform tuning of the search unit in detail according to preferences of a user.

Reduced image data where the resolution of image data is reduced is accumulated in the image database along with the image data and the determination unit determines degrees of similarity of an input image and reduced images which expresses reduced image data, so that it is possible for the tuning screen transmission unit to generate and transmit a tuning screen using the reduced images, where the degrees of similarity satisfy predetermined conditions, out of the reduced images. Since the degrees of similarity are determined using the reduced images, it is possible to reduce the amount of calculation.

According to another aspect of the invention, there is provided a similar image search method, which searches with regard to an input image from a search request origin for images which are similar to the input image from image data accumulated in the image database, including determining the degrees of similarity of the input image and each image expressed by individual image data accumulated in the image database using a plurality of determination standards obtained by applying and combining weights of differences in a plurality of characteristic values which express the characteristics of an image, and transmitting images where the determined degrees of similarity satisfy predetermined conditions to the search request origin as a tuning screen which is divided into groups for each of the determination standards.

According to still another aspect of the invention, there is provided a computer program which, by being installed in a computer, makes the computer operate as an image database where image data is accumulated in advance, a search unit which searches with regard to an input image from a search request origin for images which are similar to the input image from image data accumulated in the image database, a determination unit which determines degrees of similarity of the input image and each image expressed by individual image data accumulated in the image database using a plurality of determination standards obtained by applying and combining weights of differences in a plurality of characteristic values which express the characteristics of an image, and a tuning screen transmission unit which transmits images where the degrees of similarity determined by the determination unit satisfy predetermined conditions to the search request origin as a tuning screen which is divided into groups for each of the determination standards.

### BRIEF DESCRIPTION OF THE DRAWINGS

The invention will be described with reference to the accompanying drawings, wherein like numbers reference like elements.

FIG. 1 is a block configuration diagram of a similar image search device according to a first embodiment of the invention and an image search system including the similar image search device.

FIG. 2 is a diagram describing similar image searching.

FIG. 3 is a diagram illustrating an example of a tuning screen which is transmitted to a user by a tuning screen transmission section in the similar image search device of FIG. 1.

FIG. 4 is a flow chart of an operation of the similar image search device shown in FIG. 1.

FIG. 5 is a flow chart of a tuning process in the flow chart shown in FIG. 4.

FIG. 6 is a block configuration diagram of a similar image search device according to a second embodiment of the invention and an image search system including the similar image search device.

### DESCRIPTION OF EXEMPLARY EMBODIMENTS

Hereinafter, embodiments of the invention will be described with reference to the accompanying drawings.

### First Embodiment

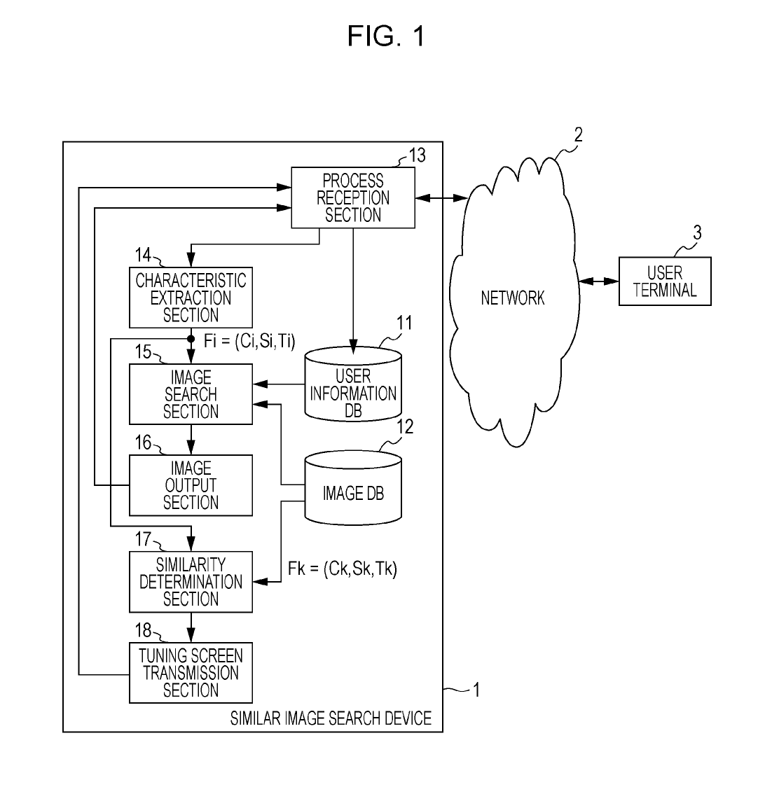

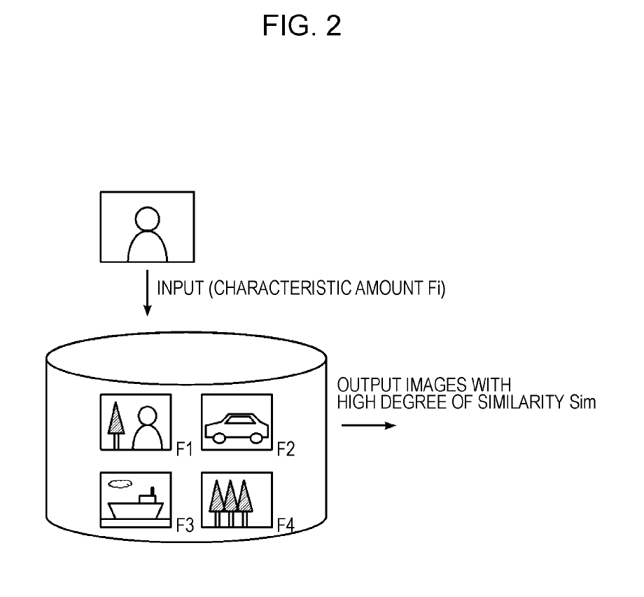

FIG. 1 is a block configuration diagram of a similar image search device 1 according to a first embodiment of the invention and an image search system including the similar image search device. In addition, FIG. 2 is a diagram describing similar image searching. Here, it is described with the similar image search device 1 being connected to a network 2 and a user accessing the similar image search device 1 from a user terminal 3 through the network 2.

The similar image search device 1 is provided with a user information database 11 (shown in the diagrams as “user information DB”), an image database 12 (shown in the diagrams as “image DB”), a process reception section 13, a characteristic extraction section 14, an image search section 15, an image output section 16, a similarity determination section 17, and a tuning screen transmission section 18. Image data is accumulated in advance in the image database 12. The characteristic extraction section 14, the image search section 15, the image output section 16, the similarity determination section 17, and the tuning screen transmission section 18 configure a search unit which searches with regard to an input image from a search request origin for images which are similar to the input image from image data accumulated in the image database 12. The similarity determination section 17 configures a determination unit which determines the degrees of similarity of the input image and each image expressed by individual image data accumulated in the image database 12 using a plurality of determination standards obtained by applying and combining weights of differences in a plurality of characteristic values which express the characteristics of an image. The tuning screen transmission section 18 configures a tuning screen transmission unit which transmits images where the degrees of similarity determined by the similarity determination section 17 satisfy predetermined conditions to the search request origin as a tuning screen which is divided into groups for each of the determination standards.

A server is used as the similar image search device 1, hardware such as a CPU, a RAM, a ROM, a hard disk, and various interfaces is provided, and functions of each section are realized using a computer program which operates under a predetermined operating system.

Information for determined preferences of a user is accumulated in the user information database 11. As information such as this, it is possible to use not only search history but also the age, sex, occupation, career, and address of a user as a reference to determine preferences of the user.

The process reception section 13 provides an interface with the user, receives a search request from the user terminal 3 via the network 2, and sends a search result, which is output from the image output section 16 and data for displaying a tuning screen, which is transmitted by the tuning screen transmission section 18, using the user terminal 3 is sent to the user terminal 3.

The characteristic extraction section 14 extracts characteristic values such as color, shape, texture, or the like from the input image data sent from the user terminal 3. The color characteristic value is expressed by, for example, a value on a color space for each pixel. The shape characteristic value is determined by template and pattern matching set in advance. The texture characteristic value is determined by a correlation calculation with a template set in advance. It is possible to use various characteristics other than color, shape and texture, but for simplicity, an example will be described below with these three characteristic values. Using characteristic values of color, shape and texture as Ci, Si, and Ti respectively, it is possible to express a characteristic amount Fi of the input information as

Fi=(Ci,Si,Ti) equation (1).

The user information database 11 and the image search section 15 operates as a unit which accumulates image search histories from the search request origin and determines preferences of the search request origin. The image search section 15 sequentially compares the characteristic value Fi extracted by the characteristic extraction section 14 and a characteristic value Fk=(Ck, Sk, Tk) where k=1, 2, . . . (k=4 in FIG. 2) of image data accumulated in the image database 12 and searches for a similar image as shown in FIG. 2 with reference to user information accumulated in the user information database 11. Here, a degree of similarity Sim of the characteristic value Fi of the input image and the characteristic value Fk of the kth image data in the image database 12 is expressed by multiplying the square of the difference of each of the characteristic values by weights Wc, Ws, and Wt so that

Sim(Fi,Fk)=Wc(Ck−Ci)²+Ws(Sk−Si)²+Wt(Tk−Ti)² equation (2).

It is possible to determine the weights Wc, Ws, and Wt from the user information accumulated in the user information database 11 such as history information of the user. The square root of equation (2) may be used as the degree of similarity Sim.

Out of the images found by the image search section 15, the image output section 16 displays a plurality of images, where the degree of similarity Sim is equal to or greater than a predetermined value, one at a time or a plurality at a time on the user terminal 3 via the process reception section 13. When the user selects one image using the user terminal 3, the process reception section 13 is notified of the selection of the image and the selection of the image is accumulated in the user information database 11 as a search history.

In a case where it is not possible to determine preferences of the user due to the image search history of the user accumulated in the user information database 11 being insufficient or in a case where there is a request from the user, the similarity determination section 17 and the tuning screen transmission section 18 perform transmission of the determination and the tuning screen respectively.

The similarity determination section 17 sets several sets of the weights Wc, Ws, and Wt in equation (2) as determination standards, and sequentially compares the characteristic value Fi extracted by the characteristic extraction section 14 and the characteristic value Fk of the images expressed by the image data accumulated in the image database 12 and searches for a similar image for each set in the same manner as the image search section 15.

The tuning screen transmission section 18 displays reduced images of the images found by the similarity determination section 17 on the user terminal 3 via the process reception section 13 as a tuning screen which is divided into groups for each of the determination standards, that is, for each set of the weights Wc, Ws, and Wt.

### Tuning

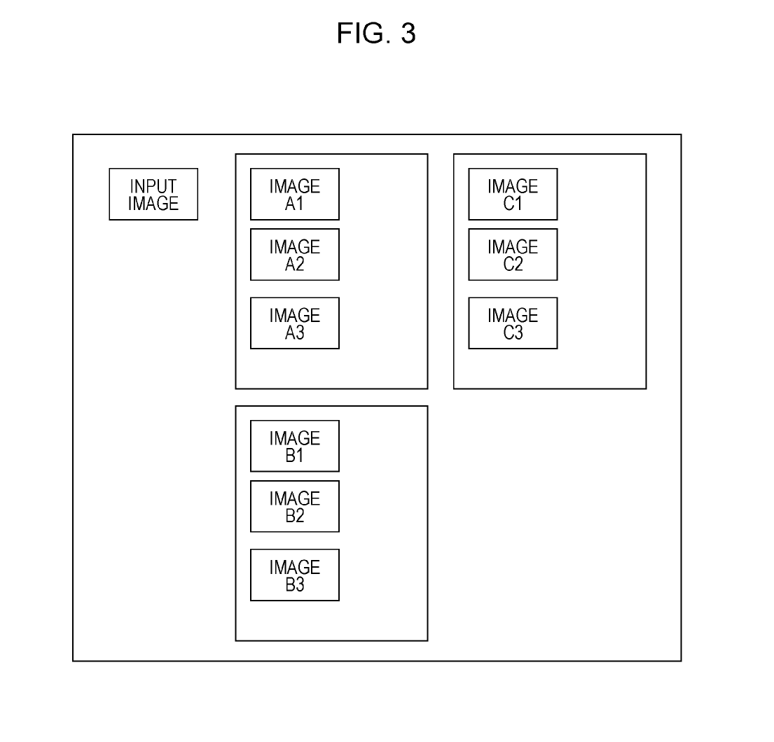

FIG. 3 is a diagram illustrating an example of a tuning screen which is transmitted to a user using a tuning screen transmission section 18. In this example, the input image and a plurality of reduced images found using four determination standards are displayed.

For example, as the weights in equation (2) which are used by the similarity determination section 17, combinations of

### Wc=1, Ws=Wt=0

### Ws=1, Wc=Wt=0

### Wt=1, Wc=Ws=0

may be used. That is, there are three combinations of a case where color is emphasized as the characteristic but shape and texture are not emphasized, of a case where shape is emphasized but the other characteristics are not emphasized, and of a case where texture is emphasized but the other characteristics are not emphasized. At this time, the similarity determination section 17 determines the degrees of similarity Sim with regard to each combination of the weights and searches for a similar image. The tuning screen transmission section 18 transmits the images with a high degree of similarity Sim respectively for each group of weights to the user. It is not necessary to transmit which characteristic was emphasized to the user.

As a result, in addition to the input image, an image where color is emphasized as the characteristic but shape and texture are not emphasized (images A1 to A3 in the example of FIG. 3), an image where shape is emphasized as the characteristic but the other characteristics are not emphasized (images B1 to B3 in the example of FIG. 3), and an image where texture is emphasized as the characteristic but the other characteristics are not emphasized (images C1 to C3 in the example of FIG. 3) are displayed in the user terminal 3 for each group. It is possible that these images may not overlap each other but overlapping may be permitted. It is possible to know which characteristic the user is emphasizing when the user selects any of these groups.

It is also possible to change the combinations of the weights and repeat the transmission to the user and the selection (tuning) by the user. For example, after using the combinations described above, it is possible to perform tuning twice with

### Wc=3, Ws=1, Wt=0

### Ws=3, Wc=0, Wt=1

and further perform tuning three times with

### Ws=5, Wc=3, Wt=1.

An example which displays the images of three groups is shown in FIG. 3, but the number thereof changes according the number of weight combinations. When the screen display is taken in consideration, with the number of images displayed for each single group is ten, it is considered that it is appropriate if the number of groups displayed is four or less. It is possible to set the number of weight combinations independently of the number of groups which are able to be displayed. For example, in a case where the number of groups which are able to be displayed is four and the number of weight combinations is five or more, the screen is switched and the 5^{th} group onward may be displayed.

### Operation Flow

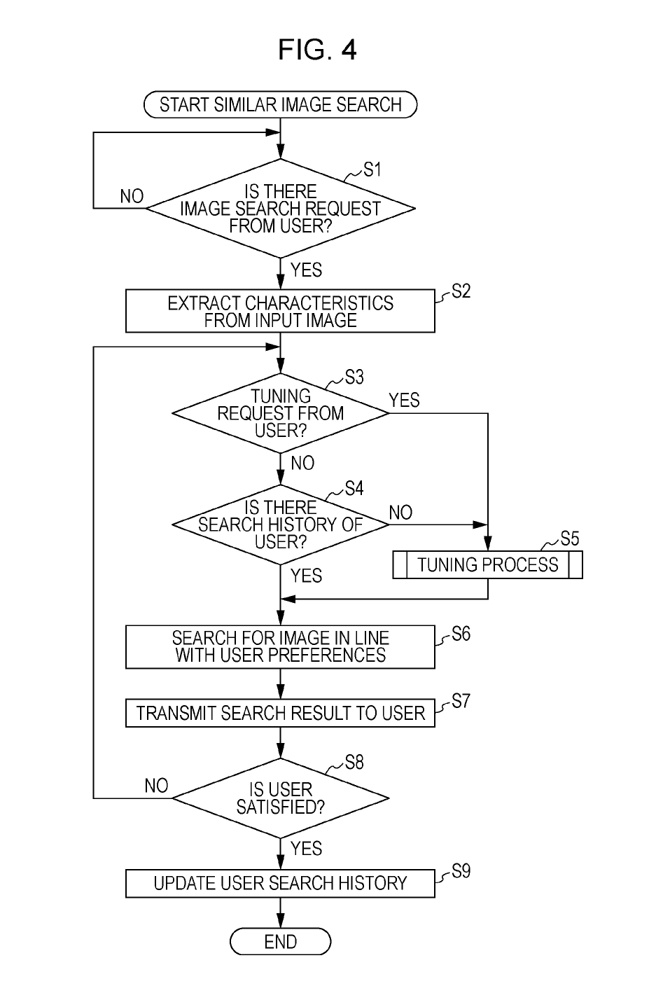

FIG. 4 is a flow chart of an operation of the similar image search device 1.

When there is an image search request from the user in the process reception section 13 (Y in step S1), the characteristic extraction section 14 extracts characteristics from the input image from the user. In a case where there is a tuning request from the user (Y in step S3) or in a case where the search history in the user information database 11 is insufficient (N in step S4), tuning is performed using the similarity determination section 17 and the tuning screen transmission section 18.

In cases where there is no tuning request from the user (N in step S3) or where there is user preference information such as a search history in the user information database 11 (Y in step S4), or after the tuning process of step S5, the image search section 15 searches for image data from the image database 12 in line with the preferences of the user. The image output section 16 transmits the search result to the user. In a case where the user is not satisfied with the search result (N in step S8), the process from step S3 onward is repeated. In a case where the user is satisfied with the search result (Y in step S8), the process reception section 13 updates the search history in the user information database 11 (step S9).

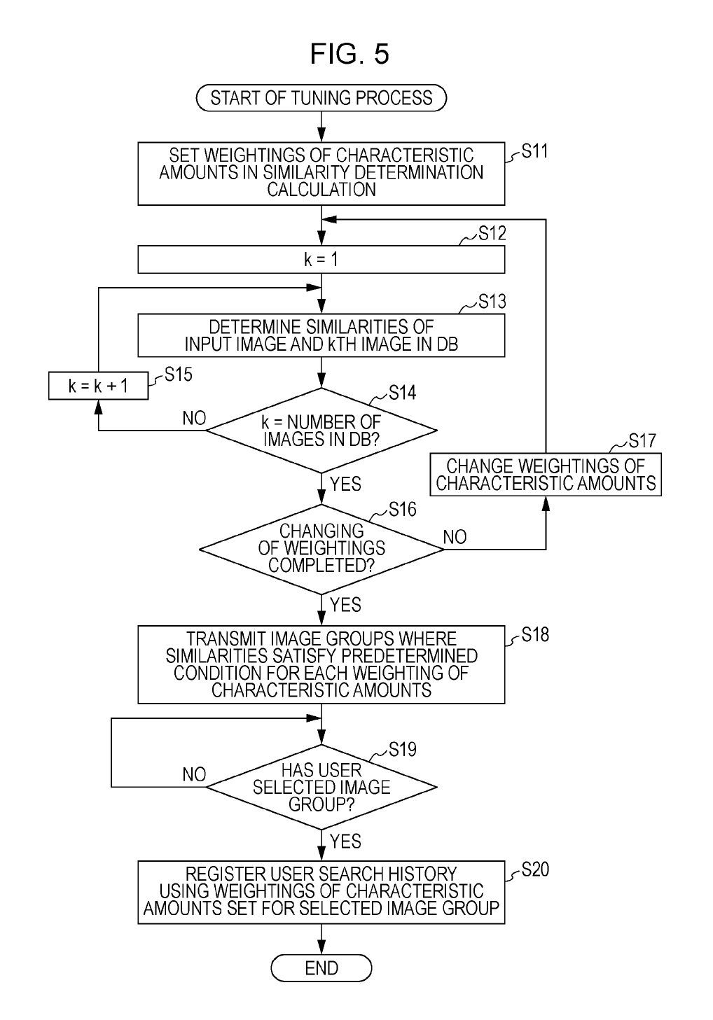

FIG. 5 is a flow chart of the tuning process in the flow chart shown in FIG. 4.

When the tuning process starts, the similarity determination section 17 sets the characteristic weights in the degree of similarity determination calculation (step S11). Next, the similarity determination section 17 sets k=1 (step S12), determines the degree of similarity of the input image and the kth image data in the image database 12 (step S13), and increments the value of k (step S15). When the determination of the degree of similarity of all of the image data in the image database 12 is completed (Y in step S14), next, it is determined whether it is necessary to change the setting of the weights (step S16), and when it is necessary (N in step S16), the weights of the characteristic amounts are changed (step S17) and the process from step S12 to step S15 is repeated.

When the weights of the characteristic amounts have been changed and the determination of the degree of similarity has been completed (Y in step S16), the tuning screen transmission section 18 transmits the image groups where the degree of similarity satisfies a predetermined condition for each set of the weights of the characteristic amounts to the user via the process reception section 13 (step S18). The selection of the image group by the user is waited for (step S19), and when selected, the process reception section 13 updates the search history in the user information database 11 using the weights of the characteristic amounts which are set for the selected image group (step S20) and it is possible to determine the preferences of the user.

### Second Embodiment

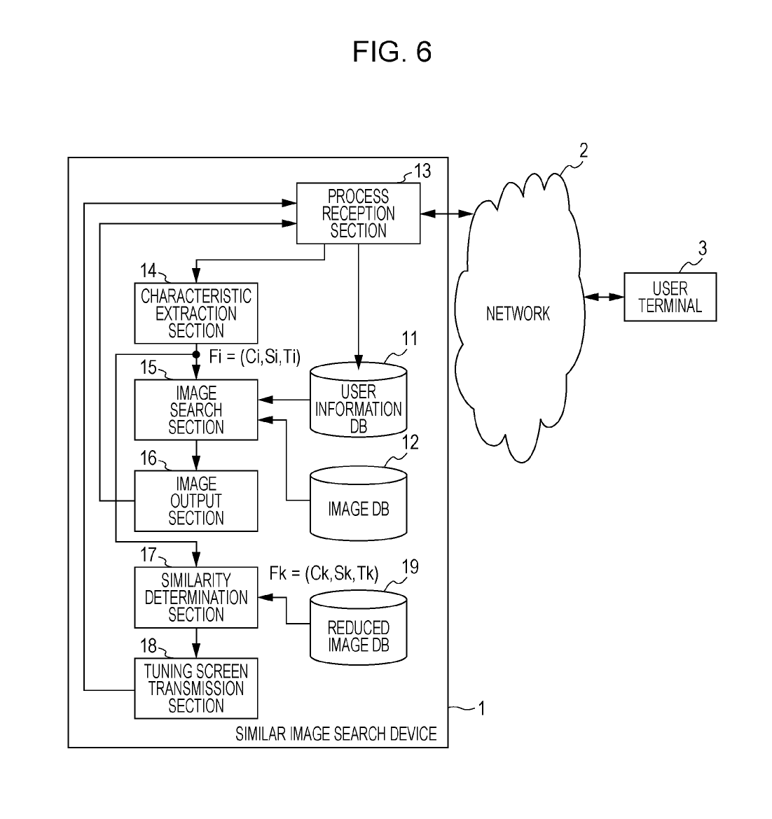

FIG. 6 is a block configuration diagram of a similar image search device 1 according to a second embodiment of the invention and an image search system including the similar image search device 1.

It is accurate for the determination of the degree of similarity to be performed with a comparison for each pixel. However, the calculation amount becomes enormous. Therefore, it is desirable to use image data where the resolution has been reduced, for example, resize data with 1600×1200 pixels to data with 64×64 pixels and to use the color and position of each pixel as characteristics. In order to achieve this, in addition to the image data which are search targets, reduced image data where the resolution of the image is reduced are accumulated in an image database. In FIG. 6, an example is shown where a reduced image database 19 where the reduced images are accumulated is provided separately from the image database 12 where the image data which are search targets are accumulated. The image database 12 and the reduced image database 19 are separate in the description here but may be one database.

In this configuration, the similarity determination section 17 determines the degrees of similarity between the input image and the reduced image data. It is possible for the tuning screen transmission section 18 to transmit the reduced image data, where the degrees of similarity satisfy predetermined conditions, out of all of the reduced image data. Since the degrees of similarity are determined using the reduced image data, it is possible to reduce the amount of calculation. In addition, it is possible to promptly display a preview with a low amount of processing using the reduced image data. It is also possible to use the reduced image data in the determination of the degrees of similarity in the image search section 15.

### OTHER EMBODIMENTS

In the description above, examples have been described of cases where only an input image is used in the searching for similar images, but it is possible to further narrow down the similar images using a combination with a keyword. In addition, in the description above, it was described that the search conditions are set in accordance with search history. However, this is not limited to the meaning of the conditions of the search being set, but includes a case where a search is performed with no weights applied, and in regard to the search result, a display order is sorted in consideration of the weights.

It is possible to use the images obtained due to the search in, for example, the recognition of faces of people. For example, as a characteristic value of the faces of people, using the outline or positional relationship of the eyes, mouth, nose, ears, and the like, each of the differences in shape and color from an average face, and the like, it is possible to determine changes in a person in an input image and people registered in a database. In addition, it is possible to be used in determining the degrees of similarity between a particular person and other people.

What is claimed is:

1. An output device which outputs images comprising:
an output unit which outputs on the same screen a first image which is determined to be similar to an input image using a first standard and a second image which is determined to be similar to the input image using a second standard,
wherein it is permitted for the first image and the second image to be the same image.

2. The output device according to claim 1,
wherein the first and second standards are modified by a user and the modified standards are stored.

3. The output device according to claim 2,
wherein an image selected by a user out of the output images is stored to correspond to information on the user.

4. The output device according to claim 3,
wherein the first and second standards are used to determine whether or not a characteristic of the input image is similar to characteristics of images in a database, and
the characteristic is any one of a group consisting of color, texture, and a shape of a subject in regard to the input image.

5. The output device according to claim 4,
wherein a degree of similarity Sim(Fi, Fk) of the characteristic of the input image and the characteristics of the images in the database is calculated by
Sim(Fi,Fk)=Wc(Ck−Ci)²+Ws(Sk−Si)²+Wt(Tk−Ti)²
where a characteristic amount of the input image Fi=(Ci, Si, Ti),
characteristic amounts of the image in the database Fk=(Ck, Sk, Tk),
Ci is a color characteristic value of the input image,
Si is a shape characteristic value of the input image,
Ti is a texture characteristic value of the input image, and
W are user-modifiable weights.

6. An output method where images are output using a CPU comprising:
outputting a first image, which is determined to be similar to an input image using a first standard, and a second image, which is determined to be similar to an input image using a second standard, on the same screen,
wherein it is permitted for the first image and the second image to be the same image.

7. A recording medium which records an output method for causing a computer to execute:
outputting of a first image, which is determined to be similar to an input image using a first standard, and a second image, which is determined to be similar to an input image using a second standard, on the same screen,
wherein it is permitted for the first image and the second image to be the same image.
